(19) United States
(12) Patent Application Publication
(10) Pub. No.: US 2017/0077572 A1
(43) Pub. Date: Mar. 16, 2017

(54) HYBRID SYSTEM FOR STORING SOLAR ENERGY AS HEAT AND ELECTRICITY

(71) Applicant: University of Wyoming, Laramie, WY (US)

(72) Inventor: Bruce A. Parkinson, Laramie, WY (US)

(73) Assignee: University of Wyoming, Laramie, WY (US)

(21) Appl. No.: 15/250,577

(22) Filed: Aug. 29, 2016

Related U.S. Application Data
(60) Provisional application No. 62/213,888, filed on Sep. 3, 2015.

(51) Int. Cl. H01M 14/00; H01M 8/20; H01G 9/20; H01M 8/18

(52) U.S. Cl. CPC H01M 14/005; H01M 8/188; H01M 8/20; H01G 9/20

(57) ABSTRACT

A photoelectrochemical system and method utilizing the photons having energies above the bandgaps of a p-type semiconductor photocathode and an n-type semiconductor photoanode with redox couples having fast electron transfer kinetics to keep overpotentials under 0.15 volts, and redox potentials energetically located within the band gaps, for storing energy in photodriven oxidation and reduction reactions separated by less than 1.6 volts using a redox flow battery configuration, are described. The photoelectrochemical system can also store heat in the flow battery generated from the inefficiencies of the photoredox reactions and from impinging photons having energies below the band gaps. Redox flow batteries contain fluid electrolyte and tanks for storing the redox equivalents, which can be used to store the solar energy not used to drive the photoredox chemistry for hot water and space heating applications. The present hybrid photoelectrochemical/thermal system may be used store excess grid electricity when electrical demand is low, or as a conventional redox flow battery in a distributed energy system, if the redox electrolyte volume was increased above that needed for solar load leveling on a daily or weekly time scale. Heat generated from the discharge of the redox battery would also be captured and stored.

### CROSS-REFERENCE TO RELATED APPLICATIONS

The present application claims the benefit of U.S. Provisional Patent Application No. 62/213,888 for “Hybrid System For Storing Solar Energy As Heat And Electricity” which was filed on Sep. 3, 2015, the entire contents of which application is hereby specifically incorporated by reference herein for all that it discloses and teaches.

### FIELD OF THE INVENTION

The present invention relates generally to photochemical cells and redox flow batteries and, more particularly, to an apparatus and method for storing solar energy as heat and electricity using an n-type semiconductor photoanode and a p-type semiconductor photocathode for both generating oxidized and reduced redox pairs, respectively, and for recovering the stored energy as electricity.

### BACKGROUND

Increasing generation of renewable energy from wind and solar sources requires effective energy storage to address the intermittent nature of these energy sources. In particular, the storage of electrical energy from photovoltaic arrays is especially daunting given that much less energy is produced in cloudy conditions and no energy is generated at night. The widespread adoption of photovoltaic solar energy production has also been hindered by intrinsic efficiency loss mechanisms in the solar panel. The overall efficiency of a pure photovoltaic array is limited by the ‘Shockley-Queisser limit where the energy from incident photons having energies greater than the bandgap of the semiconductor is lost as heat when the photogenerated carriers relax to the band edges. Additionally, photons with energy values smaller than the band gap are not absorbed and hence constitute another efficiency loss.

Alternatively, solar cell storage can be realized by photoelectrochemical cells using photocatalytic reactions of redox species. That is, by utilizing two sets of reversible redox pairs, changes taking place under light illumination can be reversed in the dark when the generated species engage in discharge reactions. Electrical energy storage using an all-vanadium system, redox flow batteries have been widely commercialized and studied. Redox flow batteries have demonstrated more than 80% electrical energy storage efficiencies utilizing redox reactions separated by <1.6 V and, using species having fast electron transfer kinetics, keep total overpotential losses to <0.12 V. The facile photo-oxidation kinetics of VO⁺² by a wide-band-gap TiO₂ photoanode have indicated that photoelectrochemical storage using such redox species can lead to a rechargeable redox flow battery. Further, the combination of flowing electrolytes containing I³⁻/I⁻ coupled with dye-sensitized solar cells and a redox flow battery, where the rechargeable stored energy was extracted using electrochemical reactions occurring on inert platinum mesh electrodes, demonstrates in principle that the solar redox concept is feasible.

The current “holy grail” of photoelectrochemical energy conversion and storage is to cost-effectively split water with sunlight. There has been considerable investment in research to meet this goal due to the environmental attractiveness of realizing a solar driven renewable hydrogen economy. However, the difficulty of finding robust semiconducting materials and facile multielectron catalysts for hydrogen and oxygen evolution has proven challenging. Therefore, it is unlikely that an efficient and cost-effective system will be available in the near future. Many of the obstacles inherent in a water splitting system may be circumvented if the solar energy was instead used to generate simple, fast redox reactions.

### SUMMARY OF THE INVENTION

Embodiments of the present invention overcome the disadvantages and limitations of the prior art by providing an apparatus and method for storing solar energy as electricity and heat without the inefficiency and complexity of separate photoelectrochemical cells and redox flow batteries.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

To achieve the foregoing and other objects, and in accordance with the purposes of the present invention, as embodied and broadly described herein, the photoelectrochemical system hereof, includes: a first chamber containing a first electrolyte comprising a first redox couple; an n-type semiconductor photoanode in contact with the first electrolyte for driving photo-oxidation of the first redox couple when sunlight impinges on the photoanode; a second chamber containing a second electrolyte comprising a second redox couple; a p-type semiconductor photocathode in contact with the second electrolyte for driving photoreduction of the second redox couple when sunlight impinges on the photocathode; and a fluid manifold for transferring the first electrolyte containing oxidized first redox couple from the first chamber to the second chamber, and for transferring the second electrolyte containing reduced second redox couple from the second chamber to the first chamber, for discharge of the first electrolyte and the second electrolyte; whereby electrical energy is available between the photoanode and the photocathode.

In another aspect of the present invention and in accordance with its objects and purposes, the method for generating electricity hereof, includes: directing sunlight onto an n-type semiconductor photoanode in contact with a first electrolyte containing a first redox couple for driving photo-oxidation of the first redox couple; directing sunlight onto a p-type semiconductor photocathode in contact with a second electrolyte containing a second redox couple for driving photoreduction of the second redox couple; and contacting the electrolyte containing the oxidized first redox couple with the p-type semiconductor photocathode, and contacting the electrolyte containing the reduced second redox couple with the n-type semiconductor photoanode, for discharging the first electrolyte and the second electrolyte; whereby electrical energy is available between the photoanode and the photocathode.

Benefits and advantages of embodiments of the present invention include, but are not limited to, providing an apparatus and method for storing solar energy as heat and electricity using a photoelectrochemical cell and a redox flow battery that, by reversing the battery flow and utilizing the semiconductor photo-electrodes running under accumulation as redox battery electrodes, reduces the cost and complexity of the present hybrid system compared to separate photovoltaic and redox flow battery combinations, provides houses and businesses installing a system that provides electricity, electrical energy storage, domestic hot water and space heating in one system with significant savings compared to separate PV and solar thermal systems, and permits stored electrical energy to be recovered on demand with up to 85% efficiency or a small commercially available electrolysis unit to be added which will provide hydrogen on demand at pressure without the need to store hydrogen.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 is a schematic representation of an embodiment of the system of the present invention illustrating the solar collection and conversion to electricity during charging, whereby a photooxidation reaction is driven in the electrolyte on an n-type semiconductor electrode at one side of a first chamber of the solar collector, a photoreduction reaction is driven in the electrolyte on a p-type semiconductor electrode by light that penetrates the n-type semiconductor on one side of an adjacent second chamber, and infrared light passing through both semiconductors is absorbed by a black absorber at the back of the electrolyte in the second chamber to further heat the electrolyte therein, such that heat may be stored, and with the capability of hydrogen on demand.

FIG. 2A is a schematic representation of a side view of an embodiment of the solar collector shown in FIG. 1 hereof illustrating an n-type semiconductor electrode disposed at the back surface of the first chamber and in electrical communication with one side of a two-sided conductive glass, and a p-type semiconductor electrode disposed on the front surface of second chamber, in electrical communication with the opposing side of the conductive glass in a tandem configuration with the n-type electrode, while FIG. 28 is a schematic representation of a front view of an embodiment of a solar panel showing a pattern of absorbers and ion selective membranes that permit the flow of counter ions needed to sustain the electroneutrality.

FIGS. 3A and 3B are a Gerischer diagrams, where the density of states on the electrolyte side is designated by DOS, and the distance inside the semiconductor is designated by x, for the semiconductor electrolyte interfaces for an n-p tandem cell, as illustrated in FIG. 2A, hereof, during photo-induced charging (FIG. 3A), and discharging in the dark (FIG. 3B).

FIG. 4A illustrates the energy band alignment for n-TiO₂ and p-NiO, FIG. B shows the energies of TiO₂ and NiO after the contact formation, where during charging the photooxidation reaction is driven on an n-type semiconductor at one side of the collector and a photoreduction reaction will be driven on the other electrode by light having penetrated the front electrode, as shown in FIG. 4C, and FIG. 4D illustrating the discharge for recovering the stored electrical energy, which will be accomplished by driving the semiconductors into accumulation by using valves, as illustrated in FIG. 1, hereof, to reverse the flow thereby exposing the n-type material to the reducing redox electrolyte and the p-type material to the oxidizing electrolyte.

FIG. 5 is a 2D representation of a 3D mesoporous system made of 200 nm to 1 μm sized particles of a transparent conductive oxide with an ALD deposited coating of a lower bandgap oxide immersed in a redox electrolyte where band bending will be present, where light impinges from either front illumination (through the electrolyte as shown) or back illumination, and the thicknesses of the porous and ALD layers doped with donors or acceptors to provide n- or p-type conductivity, respectively, to provide approximately 100% light harvesting efficiency.

### DETAILED DESCRIPTION

As stated, the overall efficiency of a pure photovoltaic array is limited by energy conversion from incident photons having energies greater than the band gap of the semiconductor being lost as heat when the photogenerated carriers relax to the band edges, and by photons having energy values smaller than the band gap not being absorbed. Therefore, a system for utilizing both the excess heat from photogenerated carriers relaxing to the band gap and the infrared photons that are below the semiconductor bandgap would be valuable. Briefly, embodiments of the present invention include a photodriven redox flow battery adapted to capture and store solar heat energy, whereby energy exceeding the band gap energy is stored in the form of energetic redox couples, while the excess solar heat energy is captured. Further, embodiments of the present invention utilize two semiconductor electrodes under accumulation to discharge the stored energy.

The present hybrid system is expected to be efficient since, if the photoredox storage system converts an obtainable 15% of the incident solar energy to stored electricity, a value that rivals current photovoltaic panels, the remaining 85% of the solar input is available for storage as heat. A system capable of providing electricity, electrical energy storage, domestic hot water, and space heating, has clear advantages over separate photovoltaic and solar thermal systems. Additionally, by incorporating an electrolysis capability into the system, the energy stored in the redox reactions could be utilized for generating hydrogen on demand.

A system using a p-type photocathode and an n-type photoanode with redox couples having fast electron transfer kinetics and redox potentials energetically located within the bandgap, is expected to be much more efficient for converting and storing solar energy than water splitting at the semiconductor electrodes. In addition, as stated, it would be straightforward to use the unused solar energy for driving the photoredox chemistry to heat the electrolyte to store and utilize the heat for hot water and space heating applications. Switching the battery flow and utilizing the semiconductor electrodes running under accumulation as redox battery electrodes will reduce the cost of this hybrid system compared to separate photovoltaic and redox flow battery combinations. An additional advantage of such a system is that it is inherently safe, since rapid, potentially catastrophic energy releases, a real hazard of many other energy storage technologies, such as traditional batteries and flywheels, are not possible.

In addition to capturing and storing solar energy, a hybrid photoelectrochemical/thermal system would be applicable to use in a distributed energy system. If the redox electrolyte volume was increased above that needed for solar load leveling on a daily or weekly timescale, it could be used as a conventional redox flow battery to store excess grid electricity from times of low electrical demand. Heat generated from the discharge of the redox battery could also be captured and stored.

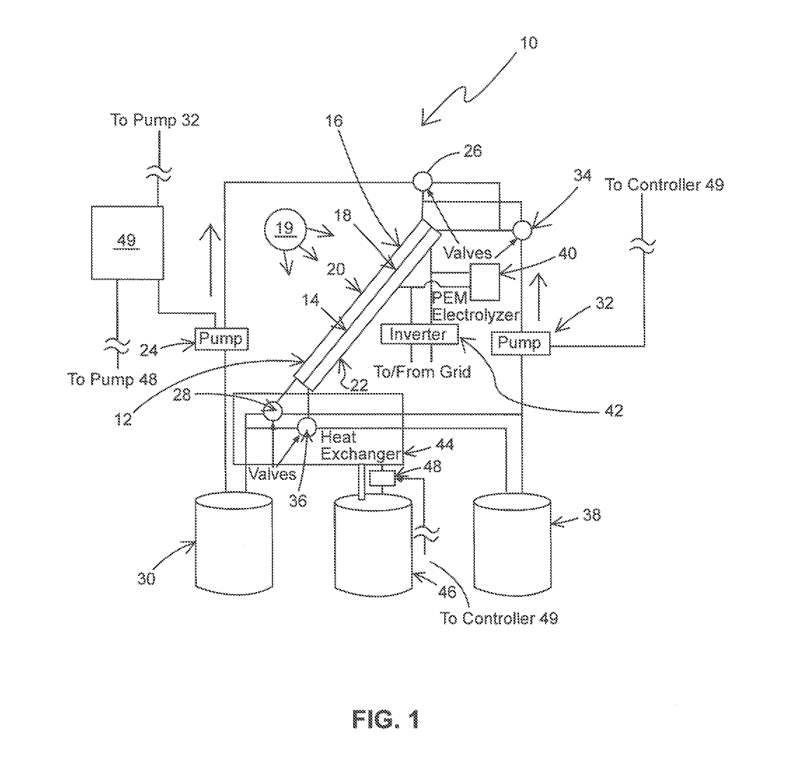

Reference will now be made in detail to the present embodiments of the invention, examples of which are illustrated in the accompanying drawings. In the FIGURES, similar structure will be identified using identical reference characters. It will be understood that the FIGURES are for the purpose of describing particular embodiments of the invention and are not intended to limit the invention thereto. Turning now to FIG. 1, a schematic representation of an embodiment of system, 10, of the present invention is illustrated, showing the concept for solar collection and conversion to electricity and stored heat with the capability of hydrogen on demand. As will be explained in more detail hereinbelow, during charging, a photooxidation reaction is driven in the electrolyte on n-type semiconductor electrode, 12, at one side of flow chamber, 14, of solar collector, 16, and a photoreduction reaction is driven in the electrolyte on p-type semiconductor electrode, 18, by sunlight, 19, penetrating electrode 12, on one side of flow chamber, 20. Infrared light passing through both semiconductors 12 and 18 is absorbed by black absorber, 22, at the back of the electrolyte in chamber 20 to further heat the electrolyte therein. Pump, 24, pumps oxidized electrolyte from chamber 14 through valves, 26, and, 28, into oxidized electrolyte storage vessel, 30, while pump, 32, pumps reduced electrolyte from chamber 20 through valves, 34, and, 36, into reduced storage vessel, 38.

Discharge for recovering the stored electrical energy is accomplished by driving the semiconductors into accumulation using pump 24 and valves 26 and 36, and pump 32 and valves 34 and 28, to reverse the electrolyte flow and expose n-type material 12 to highly reducing redox electrolyte that has a potential negative of the standard hydrogen electrode, while p-type material 18 is exposed to the highly oxidizing electrolyte that has a potential more positive than the standard hydrogen electrode. Hydrogen on demand at pressure is available by directing the electrical output to polymer electrolyte membrane (PEM) water electrolysis apparatus, 40, or the electrical output may be directed to the grid through inverter, 42.

Pipes flowing solar heated electrolyte through chambers 14 and 20 are embedded in heat exchanger, 44, through which fluid from hot water storage vessel, 46, is pumped by pump, 48, for heating. Controller, 49, operates pumps 24, 32, and 48, and valves 26, 28, 34, and 36.

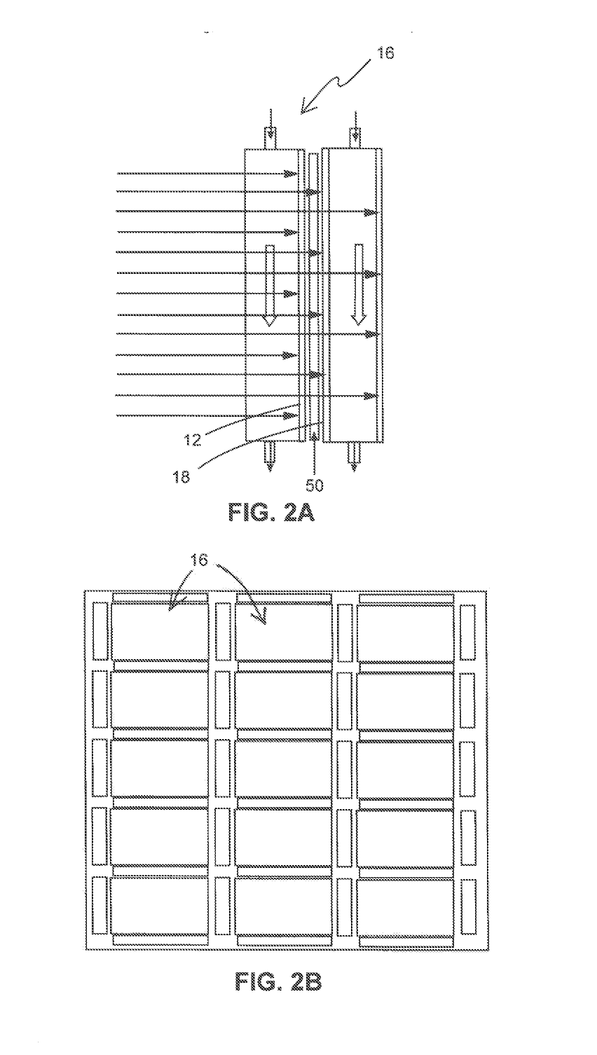

FIG. 2A is a schematic representation of a side view of an embodiment of solar collector 16 illustrating n-type semiconductor electrode 12 forming at least a portion of the back surface of flow chamber 14, in contact with the electrolyte therein, and in electrical communication with one side of two-sided conductive glass, 50, and p-type semiconductor electrode 18 forming at least a portion of the front surface of flow chamber 20, in contact with the electrolyte therein, and in electrical communication with the opposing side of glass 50 in a tandem configuration with n-type electrode 12. Electrodes 12 and 18 may be thin films deposited on the conducting glass which is part of both chambers 14 and 20. Glass plate 50 may be coated on both sides with a conducting transparent oxide. The light path and redox electrolyte flow are also shown by arrows. Infrared light passing through both semiconductors 12 and 18 is absorbed by black absorber, 22, at the back of the electrolyte in chamber 20 to further heat the electrolyte therein.

FIG. 2B is a schematic representation of a front view of an embodiment of the solar collector, showing a pattern of absorbers and ion selective membranes that permit the flow of counter ions needed to sustain the electroneutrality. An additional embodiment of the invention could have separate side-by-side panels with black backing for performing the redox reactions and thermal conversion. The n- and p-type semiconductor panels may consist of a thin film of crystalline, polycrystalline, or amorphous semiconductor material having a bandgap between about 0.9 eV and about 2.4 eV. The membrane may include a polymer or ceramic film that selectively transports protons, anions, or cation, depending on the charge of the redox couples. An example of such a membrane is Nation®, and other ion-selective membranes used in fuel cells, and electrolyzers of redox flow batteries. Membraneless designs that rely on proper design of the flow patterns (for example, see, W. A. Braff et al., in “Membrane-less Hydrogen Bromine Flow Battery,” Nature Communications, 4, 1-6 (2013), doi:10.1038/ncomms3346), are also possible.

A. Photoelectrodes:

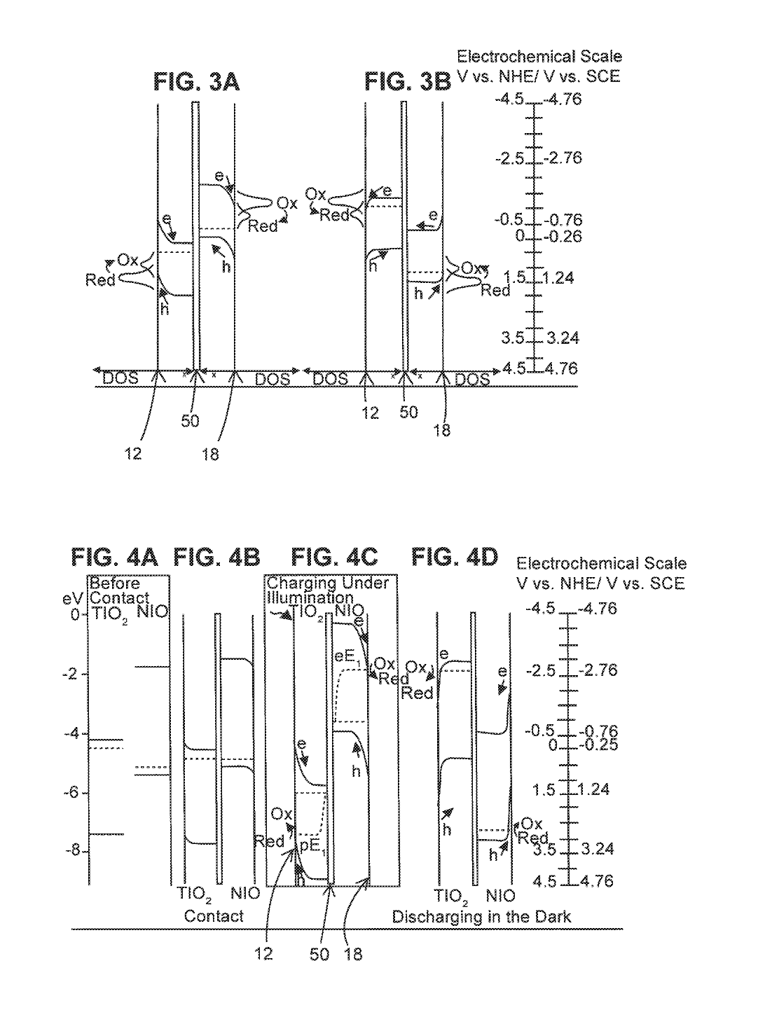

As has been demonstrated for water photoelectrolysis systems, a tandem configuration with a high bandgap material absorbing the blue end of the solar spectrum and a lower band-gap material absorbing the red and near infrared portion of the spectrum that is transmitted though the higher band gap material, yields the best efficiency. The optimum band gaps that have been identified for water splitting system are larger (˜1.9 eV and ˜1.1 eV) than those needed in the photoredox battery of embodiments of the present invention, since at least 0.4 V of overpotential is required to drive the complex multielectron and multiproton reactions necessary to split water into hydrogen and oxygen resulting in efficiency losses. Substituting simple, kinetically fast one electron transfer reactions can reduce the total overpotential to less than 0.12 V, and potentially unstable and expensive light blocking catalysts are not needed. Therefore the theoretical maximum efficiency of the present solar driven redox battery system can be greater than 25%, much higher than that for photoelectrochemcial water splitting. Gerischer diagrams for a set of n- and p-type photoelectrodes operating in the solar charging mode and the accumulation discharging mode are shown in FIG. 3.

In FIGS. 3A and 3B, the density of states on the electrolyte side is designated by DOS, and the distance inside the semiconductor is designated by x, for the semiconductor electrolyte interfaces for an n-p tandem cell, as illustrated in FIG. 2A during photo-induced charging (FIG. 3A) and discharging in the dark (FIG. 3B). The n-type material (left side of both diagrams) operating in depletion and under illumination photooxidizes the reduced form of a redox couple with a positive potential, whereas the p-type material, also illuminated in depletion, reduces the oxidized form of a redox couple with a negative potential. The stored redox energy is then recovered by switching the redox couple flow to where the negative potential redox species drives the n-type semiconductor into accumulation whereas the quite positive redox species does the same for the p-type semiconductor discharging the redox battery at as high a potential as possible from the band positions.

Single crystals permit effective control of doping density, topography, surface electronic structure and current densities, and also offer reproducibility and the highest efficiencies for converting solar energy into redox equivalents as evidenced by the high solar to electrical energy conversion efficiencies and the high efficiencies for photoelectrolysis. For example, silicon crystals are inexpensive and are available in both n- and p-type having various doping densities. Efficiencies of over 10% have been obtained for stable photoelectrochemical (PEC) n- and p-type photovoltaic (PV) cells using a methanol electrolyte with maximum power photovoltages of 0.63 V and 0.52 V, respectively. However, these crystals not completely stable when in contact with water. If substituted ferrocene/ferrocenium and cobaltacene/cobaltacenium redox couples in a nonaqueous solvent such as methanol are used, up to 1.15 volts of redox potential can be stored. Voltages can be optimized by substitutions on the cyclopentadienyl rings; for example, ferrocene derivatives may be varied from −0.138 to 0.812 V vs. SCE, while cobaltocene analogs can be varied from −0.608 to −1.568 V, as is seen in TABLE 1.

TABLE 1
A Structurally similar set of fast non-aqueous redox couples.

| Redox couple | E⁰, (V vs SCE)^{‡} |
|---|---|
| 1,1-Diacetylferrocene^{+/0} | +0.812 |
| Acetylferrocene^{+/0} | +0.582 |
| Ferrocene^{+/0} (Fc, FeCp) | +0.342 |
| 1,2,4,1′,2′,4′ Hexamethylferrocene^{+/0} | +0.042 |
| FeCp*^{+/0} | −0.138 |
| Bis(diphenylphosphinocyclopendadienyl) | −0.608 |
| cobalt molybdenum tetracarbonyl^{+/0} | |
| Bis(diphenylphosphilnocyclopentadienyl) | −0.758 |
| cobalt^{+/0} | |
| Cobaltacene (CoCp)^{+/0} | −0.988 |
| CoCp*^{+/0} | −1.568 |

Since crystalline silicon does not transmit visible light, the tandem configuration described in FIGS. 1 and 2A cannot be utilized.

Photooxidation using n-type titanium dioxide (TiO₂) and photoreduction and p-type nickel oxide (NiO) single crystal semiconductors of various aqueous redox species is also contemplated. These semiconductors have large band gaps (>3 eV), which may affect the efficiency of a solar device fabricated therefrom. Crystals of TiO₂ and MO have been used for photoelectrochemical studies. NiO and TiO₂ are commercially available as single crystals and porous networks of both materials have been prepared. Redox couples with high oxidation or reduction potentials, that may not be compatible with aqueous electrolytes, but would in principle store more energy due to the higher cell voltages, can be investigated in non-aqueous electrolytes where the flatband potentials of oxide semiconductors are not changing due to pH. However, it is anticipated that an all vanadium system, already in use for redox flow batteries, would be a good first choice, since it has significant advantages.

Homoepitaxial atomic layer deposition (ALD) of anatase and rutile forms of TiO₂ where the TiO₂ phase is templated by the substrate crystal with control of the purity and doping density of the oxide epilayer being realized, thereby enabling tuning of the conductivity and space charge layer thickness of the single crystal. Substitutional doping, by adding a niobium source in the ALD system, is preferred over the conventional method of reducing the TiO₂ by heating in vacuum or hydrogen to produce oxygen vacancies that act as donors but reduce mobility due to lattice strain associated with vacancies. It is anticipated that ALD of homoepitaxial layers of NiO on commercial NiO crystal substrates, or on a lattice matched oxide substrate, such as readily available MgO (<1% mismatch), may be used to control the doping density and corresponding space charge layer thickness on this electrode material.

FIG. 4A shows the energy band alignment for n-TiO₂ and p-NiO. The energetic positions of the bands for the respective oxides: (TiO₂: E_{CB}=−4.2 eV, E_{F}=−4.5 eV, E_{VB}=−7.4 eV; and NiO: E_{CB}=−1.8 eV, E_{F}=−5.1 eV, E_{VB}=−5.4 eV, while FIG. 4B shows the energies of TiO₂ and NiO after the contact formation. During charging the photooxidation reaction will be driven on an n-type semiconductor at one side of the collector and a photoreduction reaction will be driven on the other electrode by light that has penetrated the front electrode, as shown in FIG. 4C. Discharge to recover the stored electrical energy as shown in FIG. 4C will be accomplished by driving the semiconductors into accumulation by using valves, as illustrated in FIG. 1, hereof to reverse the flow and exposing the n-type material to highly reducing redox electrolyte, and the p-type material to the highly oxidizing electrolyte.

To maximize the stored energy, the voltage obtained for discharging the stored redox energy is maximized, the valence band energy of the n-type semiconductor would be chosen such that it has a positive potential with respect to the potential of the redox couple to be photooxidized in the gap, but near the valence band edge, while the conduction band of the p-type material would be chosen to be at a negative potential with respect to the potential of the redox couple to be photoreduced in the gap, but near the conduction band edge. In the system illustrated in FIG. 4A and 4B, the band alignment between the stable oxide semiconductors, n-TiO₂ and p-NiO, is particularly favorable for pairing these two materials in a solar redox system since the conduction band of NiO is negative and the valence band of TiO₂ is at a positive potential. Redox couples for the semiconducting photoelectrodes, operating in a depletion condition during the photoelectrolysis or storage condition (FIG. 40) can also be used for studying discharge on the other electrode material, since it will have a redox potential that drives the second electrode into accumulation (FIG. 4D).

B. Porous Electrodes:

It is anticipated that nanostructuring or microstructuring of the photoelectrode materials will be advantageous due to small carrier diffusion lengths of photogenerated carriers in oxide semiconductors, alongside the need for large surface areas to lower local current densities, and corresponding overvoltages for efficient charging and discharging reactions. Inexpensive nanocrystalline or microcrystalline photoelectrodes of TiO₂ (especially the anatase form) and NiO are routinely prepared as an electron (TiO₂) or hole (NiO) transporting scaffolds. There are a number of procedures for producing high surface area nano- to mesoporous conformal epilayers of NiO and TiO₂ electrodes on FTO (fluorine-doped tin oxide), the most common of which are doctor-blading, spin coating and hydrothermal methods. Electrodes may also be prepared on conducting nano-mesoporous scaffolds ITO (indium tin oxide).

One difference between nanocrystalline and single crystal electrodes is that there is no band bending in the nanocrystalline porous electrodes, since the particle size is smaller than any space charge field that would be formed. The high surface area is necessary to adsorb enough dye to effectively absorb all incident light, and the advantage of porosity is to lower the current densities that reduce overpotential losses and increase the amount of electrolyte in contact with the semiconductor surface to increase the faradaic efficiency due to carriers produced near the electrode surface. Therefore particle sizes up to a micron, rather than 100 nanometers or less, in porous networks would in principle be effective for a photoredox storage system. Porous electrodes with 0.2-2 μm particle sizes could support a space charge layer that would aid in photogenerated charge separation and simultaneously reduce the expected recombination of carriers that need to diffuse through a tortuous nanocrystalline network in the presence of redox species capable of recombining with the diffusing carrier. Since the present semiconductors are directly photoexcited, ultrahigh nanoporous surface areas are not needed to increase the light harvesting efficiency.

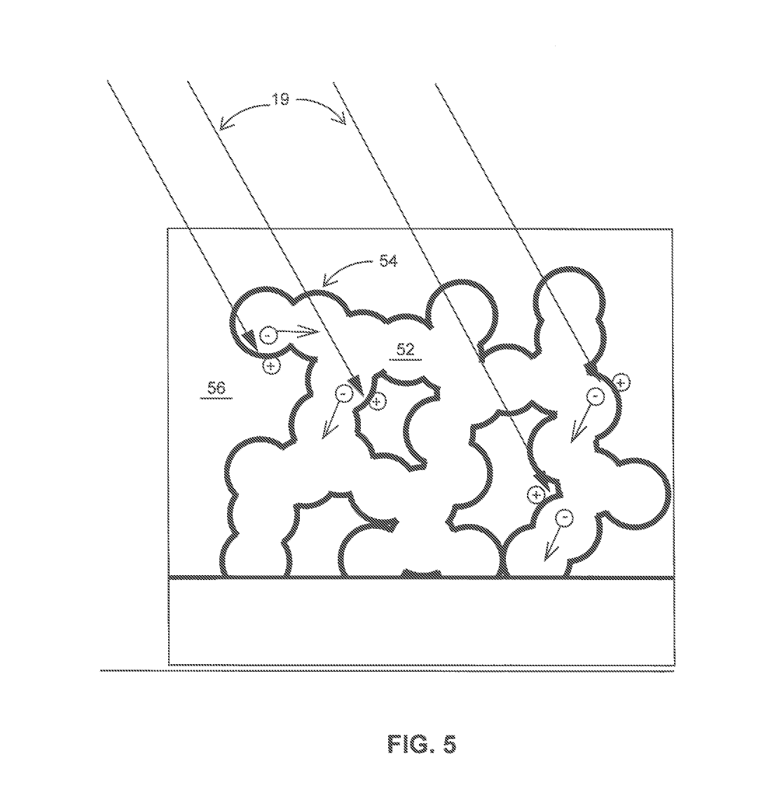

FIG. 5 is a 2D representation of a 3D mesoporous system made of 200 nm to 1 μm sized particles of a transparent conductive oxide, 52, with an ALD deposited coating of a lower bandgap oxide, 54, immersed in a redox electrolyte, 56, where band bending will be present. Light 19 impinges from either front illumination (through the electrolyte as shown) or back illumination and the thicknesses of the porous, ALD layers having n- or p-doping to optimum conductivity levels, are controlled to provide near 100% light harvesting efficiency. In this configuration all photons are absorbed in the thin ALD layers where there is a space charge layer to quickly separate the created electron hole pairs. In an n-type ALD oxide layer (shown) the electrons are conducted though the conductive oxide to the back contact and the holes are driven to the surface to oxidize the reduced form of a redox couple.

C. Low Band Gap Materials:

Lower band gap semiconducting oxides, such as α-Fe₂O₃ are not suitable since photovoltages of greater than 0.5V have not been achieved and, given its bandgap of 2.2 V, high efficiencies will not be possible. An energy diagram for a hypothetical efficient tandem photoredox flow battery is shown in FIG. 4. The photoanode materials employed in a redox storage device will need to be stable over many years under illumination in electrolytes that can be either highly acidic or highly basic. Metal oxide semiconductors that can be very stable to either oxidation or reduction may therefore be the materials of choice. Promising compositions have been identified and ALD and other thin film deposition techniques are being developed to optimize their photoresponse. In addition, it is possible to protect usually unstable photoelectrodes from corrosion by ALD deposition or electron or hole conducting oxide layers allowing the use of well known semiconductors, such as single crystal and polycrystalline silicon, CdTe, CIGS, and II-V materials (See, e.g., S. Hu et al. in “Amorphous TiO Coatings Stabilize Si, GaAs, and GaP Photoanodes For Efficient Water Oxidation,” Science, 344 (6187), 1005-1009 (2014), doi:10.1126/science.1251428).

D. Redox Couples

High power conversion efficiencies have been demonstrated for regenerative photoelectrochemical photovoltaic cells and DSSCs that use photodriven solution redox reactions. However, these devices never highly deplete the concentration of the redox minority carrier scavenger in the electrolyte since the dark counter electrode quickly reverses the photoreaction. For the purposes of energy storage in a redox flow battery it is desirable to deplete the redox carriers in the electrolyte and achieve ‘highly-charged’ and ‘highly-discharged’ states of the electrolyte. In the case of a solar pumped redox flow battery, extra redox electrolyte, above the amounts needed to store a daily input of solar energy, may be included so the unit could also store excess grid electricity during times when the electricity rates are cheap. The excess capacity would mean that the solar charging system might never highly deplete the low energy half of the redox couple on a grid-connected system. The semiconductor/redox couple junction is described by Gerischer theory where the equilibrium between the semiconductor's Fermi level and the redox potential in electrolyte is established, predominantly by charge redistribution across the semiconductor. The model is based on charge transfer between the electronic states in the photoelectrode and the energy levels in redox solution. Previous work has systematically probed the fundamentals of electron transfer kinetics at semiconductor crystal electrodes with a so-called “structurally similar redox series” many of which are listed in TABLE 1. A structurally similar redox series with very fast electron transfer kinetics minimizes and keeps the reorganization energy nearly constant when studying heterogeneous electron transfer in order to examine the influence of the semiconductor on these reactions. For example, close to Nernstian behavior was measured for the reduction of a series of substituted ferrocenes at the surface of n-InP. Fast heterogeneous rate constants were observed at other semiconductor electrodes with the rates of around 10⁵/10⁶ cm⁴/s. These fast electron couples (TABLE 1) will be investigated to measure how small an overpotential loss can be achieved in the photoreactions and dark reactions at both single crystal and porous electrodes. Lower band gap semiconductors will be needed for efficient solar conversion and will likely be paired aqueous electrolytes with energy positions like those shown in FIGS. 3 and 4. TABLE 2 lists a series of redox couples with relatively high solubility. Lower band gap oxides with the potential for long term stability will be needed, but preliminary studies in water can be conducted with p-InP and n-type transition metal dichalcogenides to extend the earlier studies of p-n photoelectrolysis systems to more redox couples than just the haloacids, since NiO is not stable in acidic aqueous solutions.

TABLE 2
Aqueous redox couples.

| Redox Couple | E⁰ (V vs SCE) | Redox Couple | E⁰ (V vs SCE) |
|---|---|---|---|
| [Ru(bpy)₃]^{3+/2+} | +1.005 | [IrCl₆]^{2-/-} | +0.705 |
| [Os(bpy)₃]^{3+/2+} | +0.820 | [Co(bpy)₃]^{3+/2+} | +0.316 |
| Ce^{4+/3+} | +1.48 | [Ru(NH₃)₆]^{3+/2+} | −0.305 |
| [Ru(CN)₆]^{4-/3-} | +0.625 | MV^{2+/+} (Methylviologen) | −0.695 |
| [Mo(CN)₆]^{4-/3-} | +0.475 | V(H₂O)₆²⁺/V(H₂O)₆³⁺ | −0.504 |
| I₃−/3I− | +0.332 | VO²⁺/VO₂⁺ | +0.757 |

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A photoelectrochemical system comprising:
a first chamber containing a first electrolyte comprising a first redox couple;
an n-type semiconductor photoanode in contact with the first electrolyte for driving photo-oxidation of the first redox couple when sunlight impinges on said photoanode, forming thereby an oxidized first redox couple;
a second chamber containing a second electrolyte comprising a second redox couple;
a p-type semiconductor photocathode in contact with the second electrolyte for driving photoreduction of the second redox couple when sunlight impinges on said photocathode, forming thereby a reduced second redox couple; and
a fluid manifold for transferring the first electrolyte containing the oxidized first redox couple from said first chamber to said second chamber, and for transferring the second electrolyte containing the reduced second redox couple from said second chamber to said first chamber, for discharge of the first electrolyte and the second electrolyte;
whereby electrical energy is available between said photoanode and said photocathode.

2. The photoelectrochemical system of claim 1, wherein said n-type semiconductor photoanode and said p-type semiconductor photocathode are driven into accumulation in discharge.

3. The photoelectrochemical system of claim 1, wherein the first redox couple has a redox potential energetically located within the bandgap of said n-type semiconductor photoanode, and the second redox couple has a redox potential energetically located within the bandgap of said p-type semiconductor photocathode.

4. The photoelectrochemical system of claim 1, wherein the first redox couple in said first electrolyte and the second redox couple in the second electrolyte have a rate constant for electron transfer greater than 10⁻² cm/s.

5. The photoelectrochemical system of claim 1, further comprising a first pump for flowing the first electrolyte through said first chamber, and a second pump for flowing the second electrolyte through said second chamber,

6. The photoelectrochemical system of claim 5, further comprising a first storage tank in fluid connection with said first chamber for storing the first electrolyte after photo-oxidation of the first redox couple, and a second storage tank in fluid connection with said second chamber for storing the second electrolyte after photo-reduction of the second redox couple.

7. The photoelectrochemical system of claim 1, wherein said n-type semiconductor photoanode is transparent to sunlight.

8. The photoelectrochemical system of claim 7, wherein said p-type semiconductor photocathode is disposed in tandem with said n-type semiconductor photoanode.

9. The photoelectrochemical system of claim 8, wherein said p-type semiconductor photocathode is transparent to sunlight having passed through said n-type semiconductor photoanode.

10. The photochemical system of claim 9, further comprising absorbing material in said second chamber for absorbing sunlight having passed through said p-type semiconductor photocathode, whereby the second electrolyte is heated.

11. A method for generating electricity comprising:
directing sunlight onto an n-type semiconductor photoanode in contact with a first electrolyte containing a first redox couple for driving photo-oxidation of the first redox couple, forming thereby an oxidized first redox couple;
directing sunlight onto a p-type semiconductor photocathode in contact with a second electrolyte containing a second redox couple for driving photoreduction of the second redox couple, forming thereby a reduced second redox couple; and
contacting the electrolyte containing the oxidized first redox couple with the p-type semiconductor photocathode, and contacting the electrolyte containing the reduced second redox couple with the n-type semiconductor photoanode, for discharging the first electrolyte and the second electrolyte;
whereby electrical energy is available between the photoanode and the photocathode.

12. The method of claim 11, wherein said n-type semiconductor photoanode and said p-type semiconductor photocathode are driven into accumulation in discharge.

13. The method of claim 11, wherein the first redox couple has a redox potential energetically located within the bandgap of the n-type semiconductor photoanode, and the second redox couple has a redox potential energetically located within the bandgap of the p-type semiconductor photocathode.

14. The method of claim 11, wherein the first redox couple in said first electrolyte and the second redox couple in the second electrolyte have a rate constant for electron transfer greater than 10⁻² cm/s.

15. The method of claim 11, further comprising the steps of flowing the first electrolyte passed the n-type semiconductor photoanode, and flowing the second electrolyte passed the p-type semiconductor photocathode.

16. The method of claim 15, further comprising the steps of storing the first electrolyte after photo-oxidation of the first redox couple, and storing the second electrolyte after the photo-reduction of the second redox couple.

17. The method of claim 11, wherein the n-type semiconductor photoanode is transparent to sunlight.

18. The method of claim 17, wherein the p-type semiconductor photocathode is disposed in tandem with the n-type semiconductor photoanode.

19. The method of claim 18, wherein the p-type semiconductor photocathode is transparent to sunlight having passed through the n-type semiconductor photoanode.

20. The method of claim 19, further comprising the step of absorbing sunlight having passed through the p-type semiconductor photocathode, whereby the second electrolyte is heated.
